(19) United States
(12) Patent Application Publication
(10) Pub. No.: US 2026/0368298 A1
(43) Pub. Date: Nov. 19, 2026

(54) BIOMETRIC VERIFICATION WITH AUTONOMY ASSESSMENT

(71) Applicant: Onfido Ltd, London (GB)

(72) Inventors: Virginia Chiarentin, London (GB); Ananias Carvalho, Lille (FR); Daniel Serrano, Lisbon (PT); Victor Camargo, Vila Nova de Gaia (PT); Maitree Thaker, Aachen (DE); André Mendes, Vila Nova de Gaia (PT); Theo Richard, London (GB)

(21) Appl. No.: 19/670,119

(22) Filed: May 7, 2026

Related U.S. Application Data
(60) Provisional application No. 63/806,933, filed on May 16, 2025.

(51) Int. Cl. G06F 21/32

(52) U.S. Cl. CPC G06F 21/32

(57) ABSTRACT

A biometric identity verification platform includes autonomy assessment capabilities. The autonomy assessment capabilities are performed in association with a biometric identity verification request, such as an enrollment or subsequent verification process. Audio data may be analyzed to determine if the user seeking verification is subject to coercion by or under the command of another user. The autonomy assessment may be based on a number of speakers present in audio data captured as part of biometric data capture (e.g., video capture), particular keywords included in the audio data, metadata associated with a user device capturing the biometric data, and the like.

### CROSS-REFERENCE TO RELATED APPLICATIONS

This application claims priority from U.S. Provisional Application No. 63/806,933 filed May 16, 2025, the entire reference of which is hereby incorporated by reference.

### BACKGROUND

Biometric identity verification systems have become increasingly sophisticated in detecting traditional fraud attempts, particularly in Know Your Customer (KYC) applications. However, fraudsters have adapted by employing social engineering tactics that combine real human subjects with automated spoofing techniques, presenting new challenges that conventional biometric solutions fail to address. As motion-based fraud detection has improved, bad actors have reverted to simpler yet effective attacks, such as coercing legitimate users during the verification process.

Current KYC biometric solutions primarily focus on detecting technical spoofing attempts, such as presentation attacks or deepfakes, while overlooking behavioral and contextual signals that could indicate coercion or manipulation. Accordingly, improvements in detection of different types of fraud detection, including those enacted through social engineering and/or coercion, are desirable.

### SUMMARY

In general terms the present disclosure relates to a biometric identity verification platform that includes autonomy assessment capabilities. The autonomy assessment capabilities are enabled such that, in at least near-real-time in association with a biometric identity verification request, such as an enrollment or subsequent verification process, audio data may be analyzed to determine if the user is subject to coercion by or under the command of another user. The autonomy assessment may be based on, e.g., a number of speakers present in audio data captured as part of biometric data capture (e.g., video capture), particular keywords included in the audio data, metadata associated with a user device capturing the biometric data, and the like.

In a first aspect, a biometric identity verification platform includes a processor and a memory communicatively connected to the processor. The memory stores instructions which, when executed by the processor, cause the biometric identity verification platform to perform: receiving a biometric verification request from a user device, the biometric verification request including video content, the video content including user biometric information and metadata; obtaining a machine-generated transcript extracted from audio content included in the video content; based, at least in part, on a number of speakers represented in the machine-generated transcript, identifying an autonomy risk event; and based on the presence of the autonomy risk event, automatically flagging the biometric verification request for review.

In a second aspect, a method includes receiving, at a biometric identity verification platform, a biometric verification request from a user device, the biometric verification request including video content, the video content including user biometric information and metadata. The method further includes obtaining a machine-generated transcript extracted from audio content included in the video content, and, based, at least in part, on a number of speakers represented in the machine-generated transcript, identifying an autonomy risk event. The method further includes, based on the presence of the autonomy risk event, automatically flagging the biometric verification request for review.

In a third aspect, a biometric identity verification platform includes a processor and a memory communicatively connected to the processor. The memory stores one or more biometric analysis models and instructions which, when executed by the processor, cause the biometric identity verification platform to perform operations including: receiving, at a biometric identity platform, a biometric enrollment request from a user device, the biometric enrollment request including video content, the video content including user biometric information and metadata associated with the user device and the video content; extracting audio content from the video content; submitting the audio content to an automated transcription service to obtain a machine-generated transcript; identifying one or more keywords in the machine-generated transcript; identifying a number of speakers represented in the machine-generated transcript; based on whether the number of speakers exceeds a first threshold and the number of keywords exceeds a second threshold, identifying an autonomy risk event; and based on the presence of the autonomy risk event, automatically flagging the biometric verification request for review.

### BRIEF DESCRIPTION OF THE DRAWINGS

FIG. 1 illustrates a system for biometric identity verification that includes autonomy assessment processing, according to an example implementation.

FIG. 2 illustrates a flowchart of an example method for performing a biometric identity verification process.

FIG. 3 illustrates a flowchart of an example method for obtaining and analyzing audio transcript information in conjunction with an autonomy assessment.

FIG. 4 is a swimlane diagram illustrating example portions of an access or enrollment process that utilizes biometric identity verification incorporating autonomy assessment processes according to the present disclosure.

FIG. 5 illustrates a sequence of mobile device user interfaces useable in a biometric identity verification process according to aspects of the present disclosure.

FIG. 6 illustrates processing of a transcript and metadata to determine an autonomy result, according to example aspects of the present disclosure.

FIG. 7 illustrates an identity verification enrollment status interface presentable to an entity requiring such access or enrollment processes using a biometric analysis platform, according to example aspects of the present disclosure.

FIG. 8 illustrates a detailed biometric enrollment summary report for a particular individual enrollee, showing biometric enrollment information and autonomy assessment results.

FIG. 9 illustrates an example computing device useable to implement aspects of the present disclosure.

### DETAILED DESCRIPTION

As briefly described above, embodiments of the present invention are directed to a biometric identity verification system that includes autonomy assessment capabilities. The autonomy assessment capabilities are enabled such that, in at least near-real-time in association with a biometric identity verification request, such as an enrollment or subsequent verification process, audio data may be analyzed to determine if the user is subject to coercion by or under the command of another user. The autonomy assessment may be based on, e.g., a number of speakers present in audio data captured as part of biometric data capture (e.g., video capture), particular keywords included in the audio data, metadata associated with a user device capturing the biometric data, and the like.

In some instances, the biometric identity verification request may take the form of a biometric identity verification enrollment request, or a subsequent verification process. In conjunction with such requests, video data of an enrolling or verifying user may be captured by a user device. Audio data may be obtained from that video data and analyzed to perform such autonomy assessments.

In some examples, the autonomy assessment is informed by an automated transcription service. The automated transcription service may be provided audio data, and create a machine generated transcript therefrom. A determination of a potential autonomy issue (e.g. a lack of autonomy) may be identified based on the presence of a greater number of speakers within the transcript that might otherwise be expected. For example, if during biometric data collection no speech is required, the presence of one or more speakers may indicate or raise a question as to the autonomy of the user who is the subject of the biometric identity verification request. If speech is required or contemplated as part of the biometric data collection, a detection of two or more speakers may indicate a potential lack of autonomy.

In further examples, either instead of or in combination with a number of speakers, presence of one or more keywords within the machine generated transcript might indicate a lack of autonomy. For example, a presence of one or more command words that might be used to coerce a user into particular behavior might be identified within the transcript. Presence of more than a predetermined number of keywords might indicate a lack of autonomy, either alone or in combination with a number of speakers present within the transcript. In some instances, the number of keywords required to suggest a lack of autonomy may be adjustable in various circumstances or in conjunction with different enrollment entities, thereby adjusting sensitivity to potential coercive behavior.

In some additional examples, metadata captured in conjunction with the video data may provide additional bases to perform autonomy assessments. For example, metadata describing a device language used may inform creation of a transcript from the audio data. Metadata describing a camera used to capture the video data may indicate which camera was used, indicating whether the user was operating a user device alone, or were assisted or directed by others.

In still further examples, various ones of the determinations of potential coercive behavior may be used alone or in combination with each other, and may be tuned for each individual test or enrollment entity to adjust sensitivity to potential coercive behavior. Accordingly, individual enrollment entities may determine sensitivity to potential coercive behavior and thereby adjust a balance between (1) lower sensitivity, with corresponding greater efficiency in automated autonomy assessment and comparatively lower numbers of requests requiring manual review and (2) higher sensitivity, with corresponding lower computational efficiency, lower levels of achieved automation in autonomy assessment, and comparatively higher numbers of requests that may require manual review for potential autonomy issues.

Referring generally to the various embodiments described herein, the methods and systems of the present disclosure address specific technical limitations that exist in the field of biometric identity verification. Specifically, traditional systems lack the capability to detect and analyze real-time social engineering signals, for example voice instructions from third parties during the verification process. Rather, such systems concentrate on post-verification signals such as personally identifiable information (PII) changes, mouse movements, and transaction patterns, and therefore are unable to effectively detect coercion, including during an initial identity verification or enrollment process.

Additionally, while some solutions attempt to monitor user behavior during verification, those systems struggle with distinguishing between legitimate assistance and coercive intervention. It can be difficult to distinguish coercion from scenarios where vulnerable users, such as elderly or differently-abled individuals, may require genuine assistance during the verification process. The inability to accurately differentiate between helpful guidance and fraudulent manipulation has left institutions requiring such biometric identity verification processes, such as financial institutions, exposed to sophisticated social engineering attacks that exploit this verification vulnerability. The systems and methods described herein, which enable at least near real-time verification of possible autonomy alerting issues, allow for ease of review of biometric data used for enrollment, and allow enrollment entities (e.g., financial institutions, governments, or other institutions that may require identity verification) to quickly review only those potentially coercive enrollment records via convenient aggregative reports and review interfaces once real-time assessment is performed.

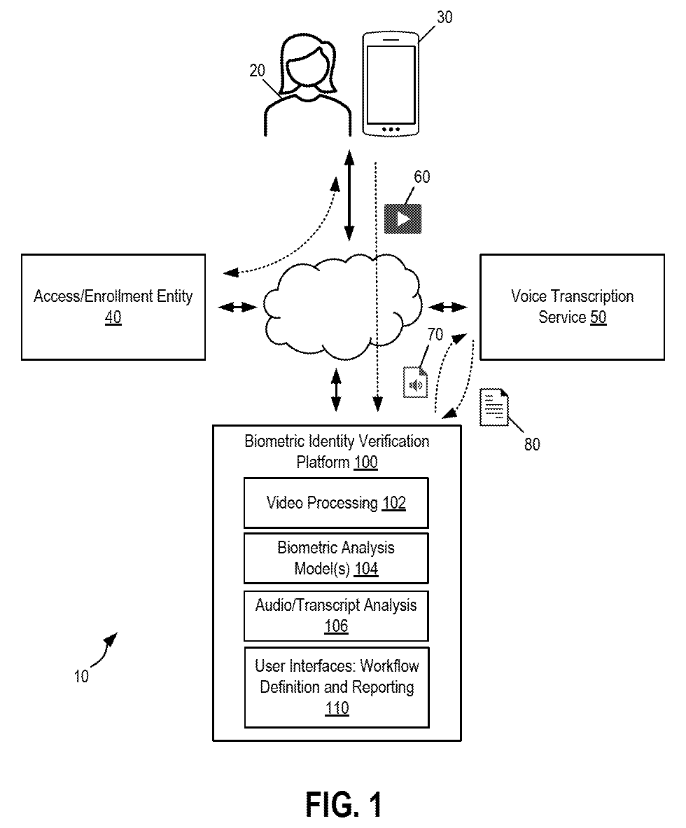

FIG. 1 illustrates an example environment 10 in which aspects of the present disclosure, including user autonomy assessment, may be implemented. In particular, FIG. 1 illustrates an environment in which a biometric identity verification platform 100 may be utilized. Generally speaking, such a biometric identity verification platform enables user enrollment and user verification upon submission of biometric information (e.g., image, audio, or video data, by way of example). As illustrated, the environment 10 includes a user 20 and related user device 30, an enrollment entity 40, a transcription service 50, and the biometric identity verification platform 100 communicatively connected to each other, e.g., via a network such as the Internet.

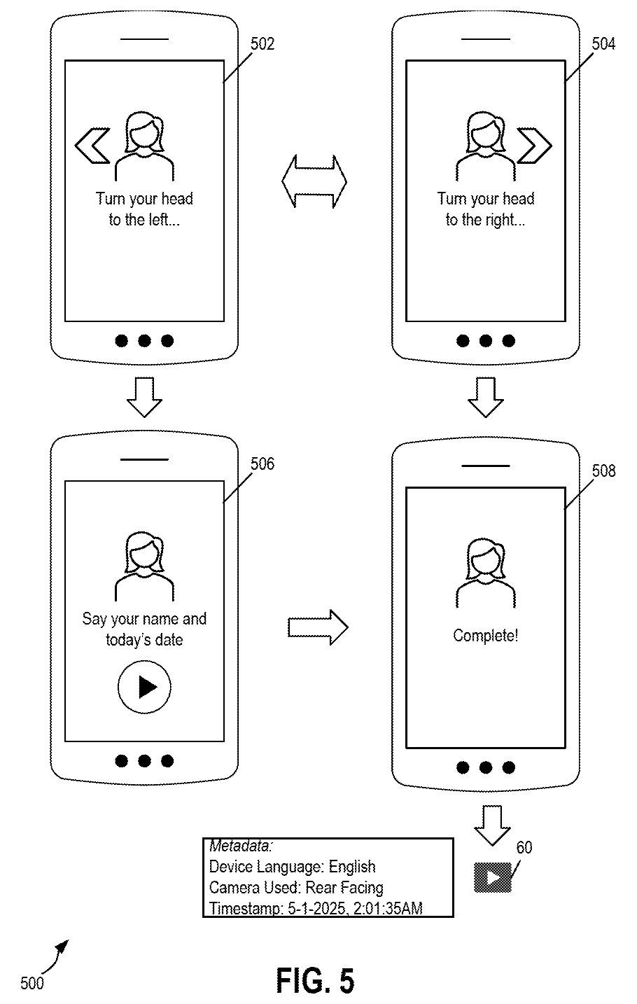

In the example shown, the user 20 represents an individual seeking access to a resource or account, for example a security source such as may be maintained by a financial institution, government, or other secure enterprise. In such instances, the user 20 may be required by that enterprise, referred to herein as the enrollment entity 40, to submit biometric data for purposes of identity verification. The user 20 may submit such biometric data via interaction with user device 30, such as a mobile device. In example use cases, the user may be prompted, via an application executing on the user device 30, to submit such biometric data. Example biometric data may include image data, audio data, fingerprint data, and the like. In the example as shown, the biometric data includes video data 60. Such video data 60 may include a selfie or self portrait of the user 20 performing one or more gestures, saying one or more responsive words, or the like. Example processes for capturing video data 60 are described in further detail below in conjunction with FIG. 5.

In example implementations, the enrollment entity 40 may coordinate to use the biometric identity verification platform 100 for purposes of biometric verification of users. Accordingly, one or more enrollment entities 40 may utilize the biometric identity verification platform 100; in the example shown, only one such entity is illustrated. In examples, when an enrollment entity 40 receives a request from a user, the user device 30, for enrollment or verification, will be redirected to the biometric identity verification platform 100, e.g., from within a mobile or web application provided by enrollment entity 40. An enrollment entity may be any entity for which biometric enrollment and verification is desired, for example a financial institution, government, or other entity having Know Your Customer (KYC) requirements, or similar.

In the example shown, the biometric identity verification platform 100 is generally configured to perform biometric identity verification on users and will response to requests from those users. Biometric identity verification involves receiving biometric data from a user and comparing that biometric data to a biometric signature previously obtained for that user. Accordingly, the biometric identity verification platform 100 may receive both enrollment requests for submitting initial biometric data of a user, as well as subsequent verification requests providing biometric data for matching to such a known user. In the example as illustrated, the biometric identity verification platform 100 includes a video processing subsystem 102, one or more biometric analysis models 104, a transcript analysis subsystem 106, and one or more user interfaces 110.

In the example shown, the video processing subsystem 102 is operable to analyze received video data, such as video data 60 to extract and interpret particular observable features in that video data. For example, in some instances the video processing subsystem wanted to main identifying particular using movements within the video data, such as the user turning his four head to the left and right, detecting open or closed eyes, detecting movement of the map, and the like. Additionally, the video processing subsystem 102 may be configured to extract particularized aspects from the video data 60. For example, the video processing subsystem 102 may extract audio data 70 from the video data 60. The video processing subsystem 102 may also extract still image frames from the video data 60.

In the example shown, the biometric analysis models 104 include one or more machine learning models usable to classify biometric information received from users. For example, one such biometric analysis model may be configured to receive video data or still image data, and extract biometric features relating to a geometry of a user's face. Such biometric features include three dimensional facial features, and may be stored as vector representations of the user. Another such biometric analysis model may be used for comparison of two sets of biometric data. For example, while an initial set of biometric data may be received as part of an enrollment process, a second set of biometric data may be received as part of a biometric verification request. One or more classifier models may be configured to compare the two sets of biometric data and determine whether the two sets of biometric data correspond to the same person, as well as a confidence level associated with the same. Additional classifier or analysis models may be used to perform a liveness assessment on the user based on received image or video data, e.g., verifying from the video data that the user is in fact present, and is not instead represented by an image or 3D model facsimile of the user.

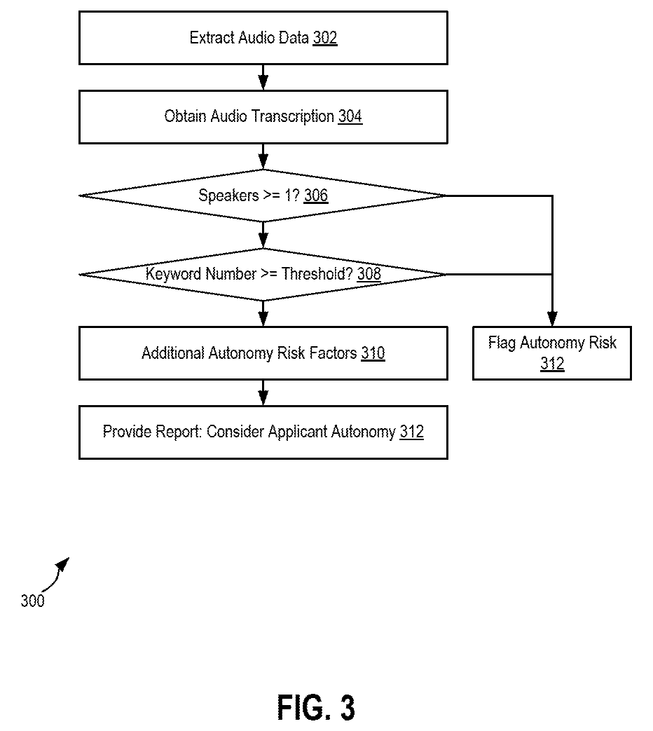

In the example shown, the transcript analysis subsystem 106 may be configured to receive a machine generated transcript 80 and perform analysis on that transcript to identify possible coercive behavior reflected therein. In some instances, the transcript analysis subsystem 106 receives the machine generated transcript 80 from a transcription service, such as transcription service 50, which is provided the audio data 70 based on video data 60 received at the biometric identity verification platform 100. The transcript analysis subsystem 106 may, in some embodiments, identify in the received transcript a number of speakers represented in the transcript. As noted below, a larger number of speakers than would be expected could be an indicator of potentially coercive behavior. The transcript analysis subsystem 106 may also maintain a command keywords list and may identify one or more keywords in the received transcript; presence of more than a threshold number of such keywords may additionally, or alternatively, indicate the presence of coercive behavior. Example details of operations of the transcript analysis subsystem 106 are provided further below in conjunction with FIG. 3.

In addition to the processes performed by the transcript analysis subsystem 106, the biometric identity verification platform 100 may be configured to perform additional autonomy assessments. For example, based on the video data 60 received at the biometric identity verification platform 100 and metadata associated therewith, there may be additional indicators or abnormalities signifying a lack of autonomy.

When a lack of autonomy is determined, for example as part of transcript and/or metadata analysis, the biometric identity verification platform 100 may be configured to identify an autonomy risk event associated with the received enrollment or verification request. On the basis of detecting an autonomy risk event, the biometric identity verification platform 100 may be configured to deny immediate approval or enrollment of the user, but instead to flag the received request for further review of the potential autonomy issue. The enrollment entity 40 may access the biometric identity verification platform 100, review any such potential autonomy issues that have occurred, and approve or deny the requests that are received. Additionally, the enrollment entity 40 may access one or more administrative parameters to adjust a sensitivity of the autonomy assessments, e.g., by adjusting a number of keywords required to be present to identify a possible autonomy issue, or to select from among the various tests of autonomy performed (e.g., selecting one or more of the number of speakers, number of keywords, and metadata-based autonomy assessments to be performed in association with requests that are associated with that enrollment entity).

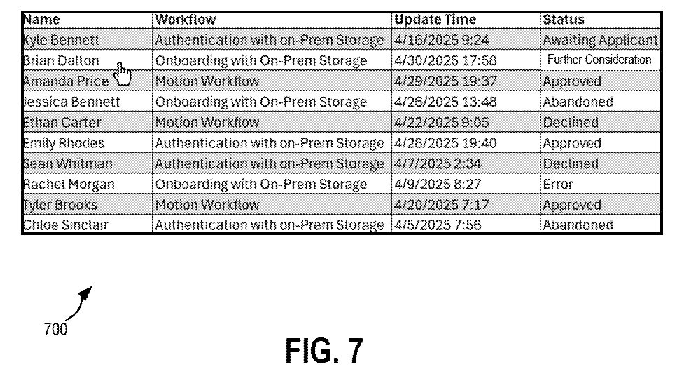

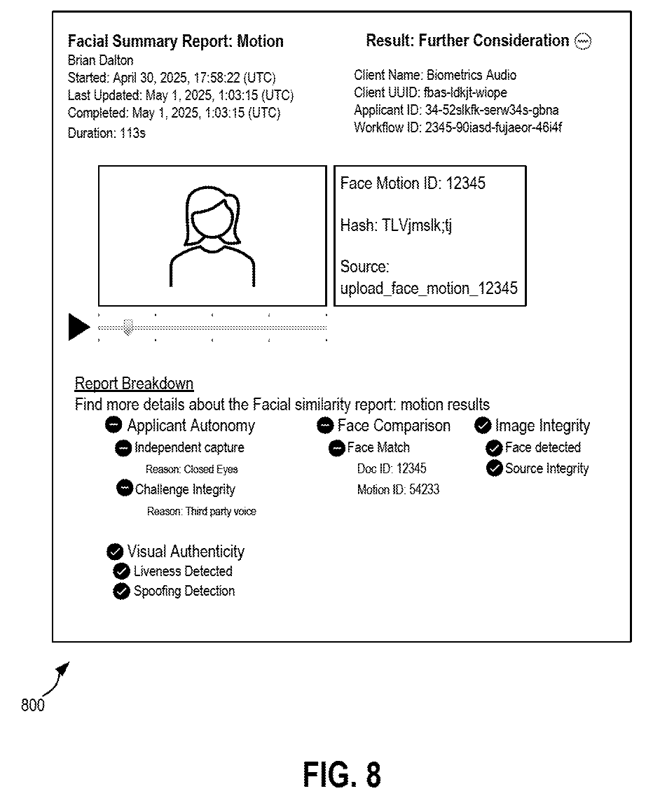

In the example shown, the user interface subsystem 110 provides a set of accessible user interfaces at which an administrative user of an enrollment entity 40 may review results of requests received at the biometric identity verification platform 100. Review of the results may be, for example, to provide manual review of possible issues that arose as part of such requests (including, but not limited to, autonomy risk events). Additionally, user interfaces generated by the user interface subsystem 110 may be presented to such a user to adjust parameters specific to the enrollment entity, for example to define a desired enrollment process (e.g., the specific motions and/or voice capture required), to define thresholds or sensitivity levels to be used as part of autonomy assessments, and/or to select the specific types of tests to be performed as part of enrollment (e.g., autonomy test selection, as well as selection of various liveness or other biometric data analysis processes). Example user interfaces generated by the user interface subsystem 110 that relate to review of completed autonomy analysis processes are described below in conjunction with FIGS. 7-8.

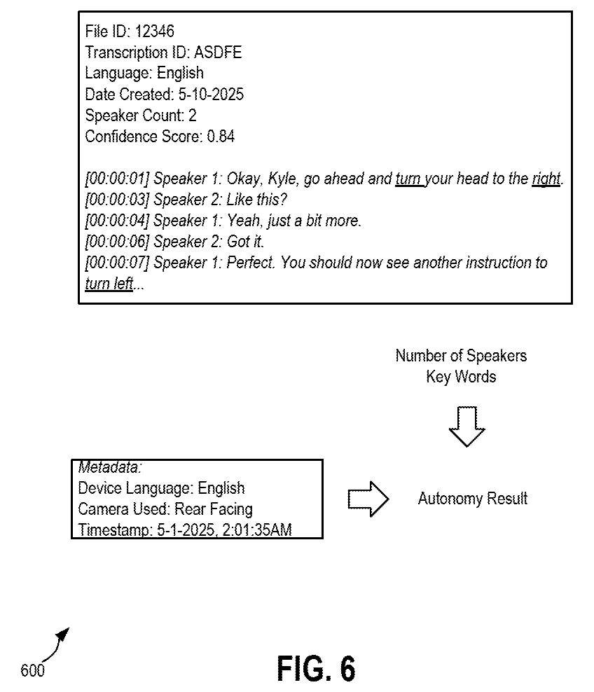

In the example shown, the transcription service 50 is configured to generate a machine generated transcript 80 from among received audio data. The transcription service 50 may be an external transcription service remote from and communicatively connected to the biometric identity verification platform 100. In some implementations the transcription service 50 may be provided using an Amazon Web Services (AWS) transcription service, e.g., AWS Transcribe. Other transcription services may be useable as well, or in the alternative. In particular implementations, the transcription service 50 receives audio data 70 in addition to one or more transcription parameters. For example, the transcription parameters may include an intended transcription language, as well as an option to provide speaker information (e.g., a number of speakers and speaker labels within the generated transcript). The intended transcription language may be derived from metadata received at the biometric identity verification platform 100 from user device 30, such as a device language setting of the user device 30. In other implementations, the intended transcription language may be selected by an enrollment entity, a user 20 at user device 30, or automatically based on language detection models. Example languages selected from among may include English, Italian, Spanish, Greek, French, Portuguese, and German. An example of a machine-generated transcript (after at least some analysis by a transcript analysis subsystem 106) is illustrated in FIG. 6.

In operation, the environment enables the biometric identity verification platform 100 to perform biometric enrollment and verification, alongside autonomy assessments, in real-time by enabling receipt of video data 60 at the biometric identity verification platform 100, routing of extracted audio data 70 to transcription service 50, and receipt of a transcript in response that may be analyzed at the biometric identity verification platform 100 for potential clues as to the presence of possibly coercive behavior at the time of enrollment or verification. This enables the biometric identity verification platform 100 to quickly determine whether to automatically enroll the user 20, to successfully verify the user, or to flag the request received from user device for further review (e.g., manual review by the enrollment entity).

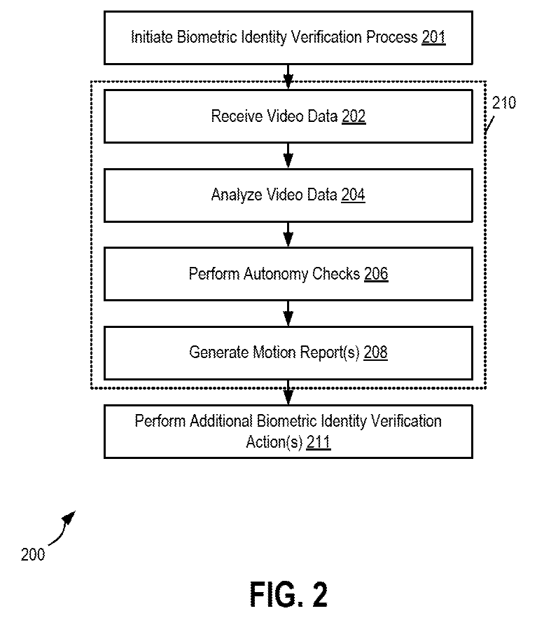

FIG. 2 illustrates a flowchart of an example method 200 for executing a biometric identity verification process. The method 200 may be performed at the biometric identity verification platform 100 in response to a request received from a user device 30 to perform such a biometric identity verification process, such as biometric identity enrollment or verification.

In the example shown, the method 200 includes initiating the requested biometric identity verification process (step 202). Initiating the requested process may include initiating an enrollment process or a verification process.

In the example shown, the method 200 receipt of video data as part of the received request (step 204). The received video data may be captured at a user device 30, for example at a mobile or web application providing user instruction to capture selfie videos. Such video data may include user motions and/or sounds, such as moving the user’s head to the left or right, up or down, and saying particular words to capture a sound signature of the user’s voice. Other processes may be performed as well; an example such process for obtaining video data is illustrated and described in conjunction with FIG. 5.

The autonomy assessment may further include validating a user based on motion signals and video analysis (step 204). Validating the user may include extracting biometric data from the received video data, and comparing that extracted data to known biometric data to determine if the user corresponds to a known user. The motion signal and video analysis may also include performing analysis of the user in the video as well as background information, for example to detect whether the user’s eyes are closed, whether there is another individual in the background of the video, whether there is evidence of involvement by another person other than the user, and the like.

In the example shown, the method 200 further includes performing autonomy checks based on the received video data (step 206). Performing autonomy checks based on received video data may include obtaining a transcript from audio data extracted from the video data, and analyzing the transcript for possible coercive behavior. Example transcript analysis processes are described below in conjunction with FIG. 3, but can include analysis of a number of speakers represented within the audio data, as well as identification of a presence of one or more keywords previously identified at the biometric identity verification platform 100 as indicative of coercive behavior, such as command words (turn, look, right, left, up, down, etc.). Identification of more than an expected number of speakers, or more than a threshold number of such command words (or a combination thereof), may be considered an indicator of possible coercive behavior requiring further review.

Performing autonomy checks may also include, for example, analyzing metadata received with the video data to determine possible indicators of coercive behavior, such as an identifier of the mobile device used to capture the video data (e.g., a same mobile device being used for a large number of requests), or an identifier of the camera used to capture the video data. Regarding the identifier of the camera, a front facing camera may indicate that the user is concurrently viewing on-screen instructions and performing the one or more requested motions as part of video data capture, while a rear-facing camera may indicate that another individual may be operating the mobile device and providing commands to the user to perform requested motions, a situation which may be indicative of coercive behavior.

In the example shown, the method 200 further includes generating a motion report in response to the request (step 208). Generally speaking, the motion report may include information obtained by the biometric identity verification platform 100 from the video data, and may include information about whether autonomy analysis checks have been automatically passed or may require further review. The motion report may also include other reasons why the request may require further review, for example due to detected issues in motion or image analysis (e.g., closed eyes, inadequate motion data, detected liveness issues, and the like). An example motion report is illustrated and described below in conjunction with FIG. 8.

Aspects of process steps 204-208 may be considered part of an autonomy assessment process 210, which may be performed in conjunction with other biometric data analysis. Accordingly, in the example shown, the method 200 includes performing one or more additional biometric identity verification actions (step 211). The additional biometric identity verification actions that are selected may be based on the request received (e.g., enrollment or verification) as well as an outcome of the biometric or autonomy analysis of video data received. Example additional verification actions may include completion of an enrollment process and storage of biometric data, or may include requesting retrial or resubmission of new biometric data to retry the enrollment process. Additional actions may also include sending one or more alerts or reports to the enrollment entity regarding patterns or behaviors detected across multiple enrollment and/or verification requests and related analyses.

FIG. 3 illustrates a flowchart of an example method 300 for obtaining and analyzing audio transcript information in conjunction with an autonomy assessment. The method 300 may be performed at the biometric identity verification platform 100, for example at transcript analysis subsystem 106 described above in conjunction with FIG. 1.

In the example shown, the method 300 includes extraction of audio data from received video content (step 302). Extraction of audio data may be performed using any of a variety of available tools for separating audio and image/video streams. The extracted audio data is then processed to obtain a transcript therefrom (step 304). Obtaining a transcript may include submitting the extracted audio to a transcription service. The transcription service may be a remote transcription service, such as transcription service 50 of FIG. 1. The transcription service 50 may return a transcript that includes various metadata including speaker identification, speaker count, and the like. An example transcript provided by such a transcription service is illustrated in FIG. 6.

In the example shown, the method 300 includes performing an analysis on a number of speakers represented in the transcript (step 306). The analysis of the number of speakers represented in the transcript is to determine whether more speakers are detected than would be expected. For example, if no speaking is required of an enrolling user, the expected number of speakers in the audio would be zero, so detecting one or more speakers may indicate the presence of a speaker providing commands to the user. If some speaking is required of the enrolling user, the expected number of speakers in the audio would be one, so detecting two or more speakers may indicate the presence of another speaker providing commands, and so on. If more speakers are detected than would be expected, an autonomy risk event is flagged (step 312).

In the example shown, the method 300 includes performing a keyword analysis on the transcript (step 308). Performing a keyword analysis on the transcript includes comparison of the text in the transcript to a list of known keywords maintained at the biometric identity verification platform 100 which are indicative of commands being given to the user. The list of known keywords may include command words and direction words in a plurality of different languages that correspond to the directions provided by the user interface of a mobile device during an enrollment or verification process as seen in FIG. 5; example keywords may include specific commands (e.g., look, turn, face, open, etc.) and directional words (left, right, up, down, etc.) in each of the selected or relevant languages. Once keywords are identified in the transcript, it may be determined if more than a threshold number of such keywords are present. The threshold may be tunable based on an enrollment entity’s desired sensitivity, as well as the number of motions requested as part of the enrollment or verification process used by that enrollment entity. Additionally, the threshold may be tunable for different languages, depending on the linguistic patterns and common instructional phrases in each supported language. For example, two or more keywords may be an appropriate selected threshold for a particular enrollment entity in a particular language (e.g., English) but a higher number of keywords may be selected by a different enrollment entity in the same language, or by the same enrollment entity in a different language. If more keywords are detected than the threshold, an autonomy risk event is flagged (step 312).

In the example shown, the method 300 further includes analyzing one or more additional autonomy risk factors to determine whether an autonomy risk event should be identified (step 310). The additional autonomy risk factors may include, for example, an identification of whether a camera used to capture the video data is a front facing camera (indicating that the user is likely operating the user device by themselves) or a rear facing camera (indicating that the user cannot see the instructions presented on screen, and therefore another user may be assisting with the biometric data capture process). The additional autonomy risk factors may also include a detection of another individual’s face or hand in the background of the video data, indicating presence of another individual in close proximity to the user of the user device. Additionally, the user’s eyes being closed may be detected, such that a biometric identification or enrollment cannot accurately be performed.

It is noted that, although autonomy risk events may be flagged, the autonomy assessments described in FIG. 3 may continue to perform other types of autonomy assessments as may be configured by the enrollment user. This allows a complete enrollment process to be summarized for the enrollment user, and allows for after-the-fact review and approval of the enrollment process even where suspected coercive behavior is detected, rather than aborting the process upon detecting any initial suspicious activity.

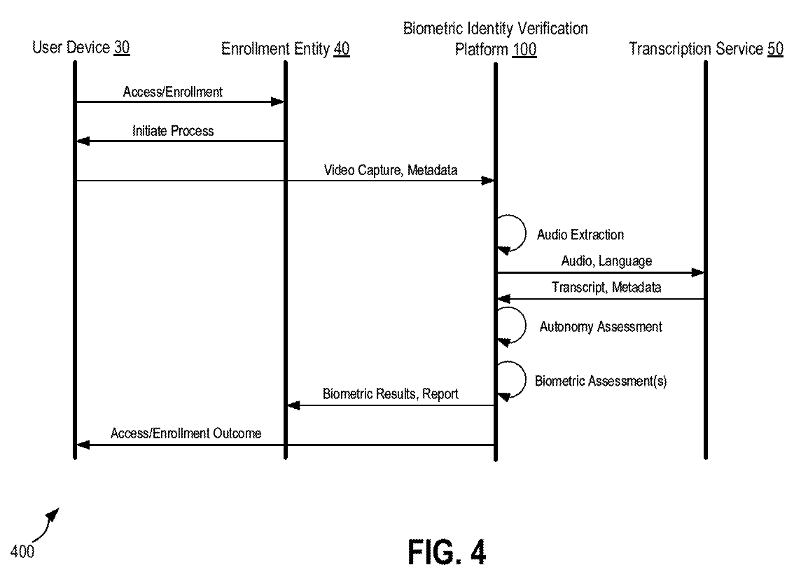

FIG. 4 illustrates a swimlane diagram 400 depicting the interaction flow between system components during an access or enrollment process utilizing biometric identity verification with autonomy assessment capabilities. The diagram shows the sequential communication between the user device 30, enrollment entity 40, the biometric identity verification platform 100, and the transcription service 50 of FIG. 1. The process begins in response to an access or enrollment request from the user device 30, for example to initiate enrollment with the enrollment entity 40. The enrollment entity 40 may initiate an enrollment process, thereby redirecting the user device 30 to the biometric identity verification platform 100 to perform an enrollment process as illustrated in FIG. 5.

The enrollment process may result in the user device 30 sending video data and metadata to the biometric identity verification platform 100. The biometric identity verification platform 100 may then perform an extraction of audio data from the video data, and provide the audio data and a selection of a transcription language to the transcription service. In some instances, the transcription language is selected at the biometric identity verification platform 100 based on a device language represented in the metadata received from the user device 30; in other examples, the transcription language may be selected based on user preferences, or may be omitted entirely (with language then detected by the transcription service).

In the example shown, the transcription service 50 returns a transcript and metadata to the biometric identity verification platform 100. The metadata may include information about the transcript, including a number of speakers in the transcript, a time of transcription, number of words, timestamps associated with transcribed phrases, and the like. The transcript and metadata received may correspond to transcript 80 of FIG. 1. The biometric identity verification platform 100 may then perform one or more autonomy assessments based on the received transcript and biometric assessments based on the video data, as described above in conjunction with FIGS. 1-3.

Based on the autonomy assessments and biometric assessments, a result of the biometric verification process is then logged and may be provided, in a report, to the enrollment entity 40. Additionally, an outcome of the individual request may be returned to the user device 30, for example to indicate a successful enrollment or verification, a failed enrollment or verification, a request to retry all or a portion of that enrollment, or a message indicating that further review of the received enrollment information and biometric information is required prior to approval.

Referring to FIG. 4 generally, the diagram 400 illustrates a process that occurs in at least near real-time, other than, in some cases, portions of the reporting processes described. Accordingly, biometric analysis and autonomy analysis may be performed immediately upon receipt and processing of the video data, resulting in substantial numbers of near-real-time approvals or enrollments of users without needing human review or intervention, while flagging for the enrollment entity those instances in which review may be required or where abnormalities may arise.

FIG. 5 presents a sequence 500 of user interfaces 502-508 presentable on a mobile device, such as user device 30, to guide a user through a biometric identity verification process, such as an enrollment process. Based on the information captured during presentation of the user interfaces by the user device 30, a request is then submitted to the biometric identity verification platform 100, as discussed above.

In the example shown, the user interfaces 502-508 illustrate specific user actions to be performed for comprehensive biometric data collection. For example, user interfaces 502, 504 instruct a user 20 to perform head movement challenges, specifically to turn their head to the left (user interface 502) and to the right (user interface 504). These may be presented to the user in any order, and may be required to be repeated one or more times. Alternatively or additionally, the user 20 may be prompted, via user device 30, to turn their head up or down, or make a different type of gesture.

Additionally, the user 20 may be prompted to provide voice data via a further interface 506. In the example shown, the user is requested to say his or her own name, as well as a current date. Other phrases that are readily identifiable may be used instead; for example, a same phrase may be used for all users to capture a common vocal signature. This voice capture may provide the ability to perform both biometric voice analysis and audio content for autonomy assessment. Typically, the requested phrase of the user will not include any, or a significant number, of words or phrases that may be included in or confused for words in the keywords list maintained by the biometric identity verification platform 100 as potentially coercive commands.

A completion user interface 508 may be presented upon user completion of the one or more gestures or responsive actions required in user interfaces 502-506, indicating successful capture of all relevant biometric data. In response to capture of all such relevant information, the captured video data (including image and audio data) may be transmitted, along with metadata regarding the session used to capture that video data, to the biometric identity verification platform 100. The metadata may include, as illustrated, a device language of the user device 30 (in this case, English), an identification of the camera used (the “rear facing” camera in this case), and a timestamp indicating when biometric data capture occurred. This metadata may be used for both biometric analysis and autonomy assessment processes, as described herein.

It is noted that although a variety of gesture and speech challenges are reflected in FIG. 5, this may typically be performed during biometric identity capture occurring during an enrollment process, and a different type or amount of biometric information may be captured during a subsequent identity verification process. For example, motion challenges may be required during enrollment to determine liveness, but either a smaller subset of motion challenges may be required of a user during verification, or motion challenges may be excluded entirely. Even in these cases, background audio may be captured to detect the presence of other users in the vicinity of the user during such biometric verification.

FIG. 6 is a schematic diagram of a process 600 for analyzing a transcript and metadata to determine an autonomy result, according to example aspects of the present disclosure. The process 600 may be performed, for example, by the biometric identity verification platform 100, including use of the transcript analysis subsystem 106 as described above, once a transcript 80 is received from a transcription service 50 as described above.

In the example shown, the process 600 includes extraction from a transcript of a number of speakers and a number of keywords included in the transcript. In some cases, as illustrated, the number of speakers will be provided in metadata associated with the transcript. In other cases, the transcript analysis subsystem 106 may analyze the text of the transcript to identify a number of unique labeled speakers (e.g., Speaker 1, Speaker 2 as shown) are included in the text. Additionally, the number of keywords may be extracted by parsing the text of the transcript and comparing to a keyword list as described previously. This information, combined with metadata captured as part of the video data capture process described above in conjunction with FIG. 5, may be used to arrive at an autonomy result based on the processes described above in conjunction with FIGS. 1-4.

FIGS. 7-8 illustrate user interfaces presentable by the biometric identity verification platform 100 to an enrollment entity, such as enrollment entity 40, indicating results of enrollment requests received at the biometric identity verification platform 100 in association with that enrollment entity. The user interfaces enable an enrollment entity to quickly review results of enrollment requests and see details of an individual enrollment request, including analysis of autonomy and other possible fraud issues that may be occurring as part of such an enrollment request.

FIG. 7 illustrates an identity verification enrollment status interface 700 presentable to an entity requiring such access or enrollment processes using a biometric identity verification platform, according to example aspects of the present disclosure. The identity verification enrollment status interface 700 displays, in a table format, individual entries of a plurality of identity verification requests associated with the enrollment entity. Each entry is associated with a different user and includes a user name, an enrollment or verification workflow that was performed (e.g., Authentication, Onboarding, Motion Workflow, and the like), timestamped indications of when the tasks were performed, and current status indicators that reflect an outcome of each workflow. Example status indicators include “Awaiting Applicant”, “Approved”, “Declined”, “Further Consideration”, “Abandoned”, and “Error”. Selection of one of the entries in the identity verification enrollment status interface 700 enables a user to readily see details of the specific workflow performed, with an example of selecting a “Further Consideration” interface shown in FIG. 8.

FIG. 8 illustrates a detailed biometric enrollment summary report 800 for a particular individual enrollee, showing biometric enrollment information and autonomy assessment results. The biometric enrollment summary report 800 may be presented to a user associated with the enrollment entity (e.g., an administrative user) in response to selection of a particular one of the entries in the identity verification enrollment status interface 700 of FIG. 7.

In the example shown, the biometric enrollment summary report 800 includes various descriptive metadata regarding the workflow performed and biometric information captured from a user as part of an enrollment or verification request. In the example shown, a user name, a start date, an update date, a completion data, a duration, as well as various unique identifiers of the applicant, workflow, and client system are captured. The biometric enrollment summary report 800 includes a playback region enabling the reviewing user to view the video data submitted by the enrollee user, including gestures performed in response to challenges presented as seen in FIG. 5. The biometric enrollment summary report 800 further includes details of how and why various tests passed or failed, including various autonomy assessments. In the example illustrated, an applicant autonomy assessment did not pass because a number of autonomy risk events were detected, including presence of a third party voice based on the transcript analysis described herein. Other tests for autonomy (e.g., closed eyes, rear facing camera, and the like) may be presented here as well, in conjunction with results of other tests for quality or integrity of biometric data, liveness assessment, and the like may be displayed.

Overall, the biometric enrollment summary report 800 presents an overall result (in this case “Further Consideration”) indicating the outcome of the biometric enrollment process. The reviewing user may then take one or more actions to, e.g., review and approve the enrollment, reject the enrollment attempt, adjust risk thresholds, and the like.

In example embodiments, the user interfaces 700, 800 may be made available to administrative users of the biometric identity verification platform 100, for example to tune parameters, add keywords, adjust biometric models, and the like, as new forms of biometric fraud and coercion appear and/or become more common.

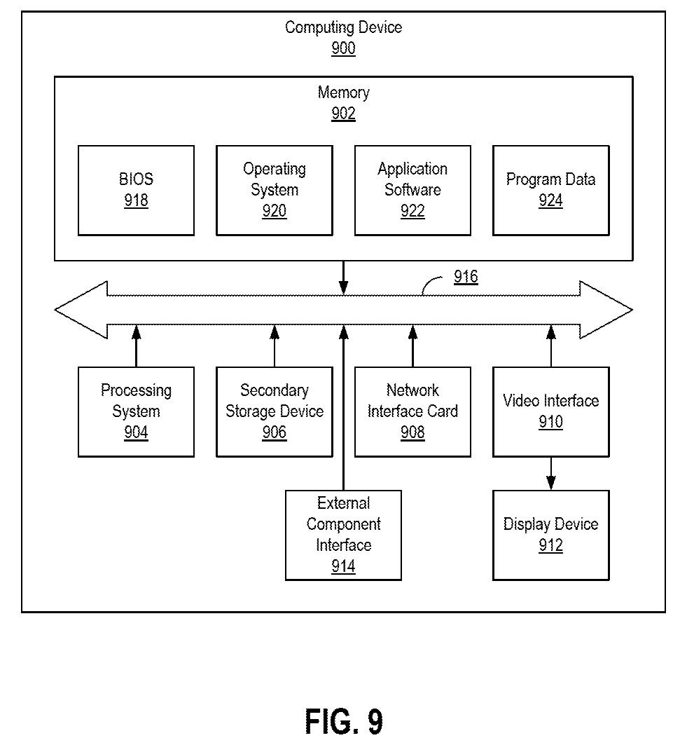

FIG. 9 illustrates an example computing system 900 on which aspects of the present disclosure may be implemented. The computing device 900 can be used, for example, to implement computing devices such as the biometric identity platform 100, enrollment entity 40, transcription service 50, or user device 30.

In the example of FIG. 9, the computing device 900 includes a memory 902, a processing system 904, a secondary storage device 906, a network interface card 908, a video interface 910, a display unit 912, an external component interface 914, and a communication medium 916. The memory 902 includes one or more computer storage media capable of storing data and/or instructions. In different embodiments, the memory 902 is implemented in different ways. For example, the memory 902 can be implemented using various types of computer storage media, and generally includes at least some tangible media. In some embodiments, the memory 902 is implemented using entirely non-transitory media.

The processing system 904 includes one or more processing units, or programmable circuits. A processing unit is a physical device or article of manufacture comprising one or more integrated circuits that selectively execute software instructions. In various embodiments, the processing system 904 is implemented in various ways. For example, the processing system 904 can be implemented as one or more physical or logical processing cores. In another example, the processing system 904 can include one or more separate microprocessors. In yet another example embodiment, the processing system 904 can include an application-specific integrated circuit (ASIC) that provides specific functionality. In yet another example, the processing system 904 provides specific functionality by using an ASIC and by executing computer-executable instructions.

The secondary storage device 906 includes one or more computer storage media. The secondary storage device 906 stores data and software instructions not directly accessible by the processing system 904. In other words, the processing system 904 performs an I/O operation to retrieve data and/or software instructions from the secondary storage device 906. In various embodiments, the secondary storage device 906 includes various types of computer storage media. For example, the secondary storage device 906 can include one or more magnetic disks, magnetic tape drives, optical discs, solid-state memory devices, and/or other types of tangible computer storage media.

The network interface card 908 enables the computing device 900 to send data to and receive data from a communication network. In different embodiments, the network interface card 908 is implemented in different ways. For example, the network interface card 908 can be implemented as an Ethernet interface, a fiber optic network interface, a wireless network interface (e.g., WiFi, WiMax, Bluetooth, etc.), or another type of network interface.

In optional embodiments where included in the computing device 900, the video interface 910 enables the computing device 900 to output video information to the display unit 913. The display unit 913 can be various types of devices for displaying video information, such as an LCD display panel, a plasma screen display panel, a touch-sensitive display panel, an LED or OLED screen. The video interface 910 can communicate with the display unit 313 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 914 enables the computing device 900 to communicate with external devices. For example, the external component interface 914 can be a USB interface and/or another type of interface that enables the computing device 900 to communicate with external devices or peripheral devices integrated within the same housing (e.g., in the case of mobile devices). In various embodiments, the external component interface 914 enables the computing device 900 to communicate with various external components, such as external storage devices, input devices, speakers, modems, media player docks, other computing devices, scanners, digital cameras, and fingerprint readers.

The communication medium 916 facilitates communication among the hardware components of the computing device 900. The communications medium 916 facilitates communication among the memory 902, the processing system 904, the secondary storage device 906, the network interface card 908, the video interface 910, and the external component interface 914. The communications medium 916 can be implemented in various ways. For example, the communication medium 916 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, or another type of communications medium.

The memory 902 stores various types of data and/or software instructions. The memory 902 stores a Basic Input/Output System (BIOS) 918 and an operating system 920. The BIOS 918 includes a set of computer-executable instructions that, when executed by the processing system 904, cause the computing device 900 to boot up. The operating system 920 includes a set of computer-executable instructions that, when executed by the processing system 904, cause the computing device 900 to provide an operating system that coordinates the activities and sharing of resources of the computing device 900. Furthermore, the memory 902 stores application software 922. The application software 922 includes computer-executable instructions, that when executed by the processing system 904, cause the computing device 900 to provide one or more applications. The memory 902 also stores program data 924. The program data 924 is data used by programs that execute on the computing device 900.

Although particular features are discussed herein as included within an electronic computing device 900, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks, and other types of devices and/or articles of manufacture that store data. Communication media may be embodied by computer readable instructions, data structures, program modules, or other data in a modulated data signal, such as a carrier wave or other transport mechanism, and includes any information delivery media. The term "modulated data signal" may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 900 of FIG. 9, the computer-readable instructions are stored on devices that include non-transitory media. In particular embodiments, the computer-readable instructions are stored on entirely non-transitory media.

Referring to FIGS. 1-9 generally, the biometric identity verification platform 100 of the present disclosure has a number of advantages provided by the autonomy assessments provided herein, when considered in combination with other biometric assessment processes provided by that platform. Because the system provides real-time detection of social engineering signals including voice instructions, it addresses technical limitations of existing biometric verification systems that are limited to assessment of transaction patterns, mouse movements, and the like. Furthermore, the platform is extensible to add other types of autonomy checks, and to select from among the available autonomy assessments, accommodating new types of coercive behavior that may emerge. The customized sensitivity for various users and languages enables customization of the tradeoff between sensitivity and extent of automation, with lower sensitivity resulting in less thorough screening and higher automation, and higher sensitivity resulting in a more thorough screening but the potential side effect of increased manual review.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of biometric enrollment processes, technologies disclosed herein are applicable to data and methods for identity verification generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A biometric identity verification platform comprising:
a processor;
a memory communicatively connected to the processor, the memory storing instructions which, when executed by the processor, cause the biometric identity verification platform to perform:
receiving a biometric verification request from a user device, the biometric verification request including video content, the video content including user biometric information and metadata;
obtaining a machine-generated transcript extracted from audio content included in the video content;
based, at least in part, on a number of speakers represented in the machine-generated transcript, identifying an autonomy risk event; and
based on presence of the autonomy risk event, automatically flagging the biometric verification request for review.

2. The biometric identity verification platform of claim 1, wherein automatically flagging the biometric verification request for review occurs in at least near real-time in response to the biometric verification request.

3. The biometric identity verification platform of claim 1, wherein the instructions cause the biometric identity verification platform to perform:
extracting the audio content from the video content; and
submitting the audio content to an automated transcription service to obtain the machine-generated transcript.

4. The biometric identity verification platform of claim 1, wherein the instructions cause the biometric identity verification platform to perform:
identifying one or more keywords in the machine-generated transcript,
wherein identifying the autonomy risk event is further based on presence of more than a predetermined number of keywords in the machine-generated transcript.

5. The biometric identity verification platform of claim 4, wherein the one or more keywords are identified by way of comparison to a keyword list of command keywords maintained at the biometric identity verification platform.

6. The biometric identity verification platform of claim 1, wherein the biometric verification request comprises a biometric enrollment request.

7. The biometric identity verification platform of claim 1, wherein the instructions further cause the biometric identity verification platform to perform an additional autonomy risk assessment that is based, at least in part, on the metadata identifying a camera of the user device used to capture the video content from among a front-facing camera and a rear-facing camera of the user device to identify the autonomy risk event.

8. A method comprising:
receiving, at a biometric identity verification platform, a biometric verification request from a user device, the biometric verification request including video content, the video content including user biometric information and metadata;
obtaining a machine-generated transcript extracted from audio content included in the video content;
based, at least in part, on a number of speakers represented in the machine-generated transcript, identifying an autonomy risk event; and
based on presence of the autonomy risk event, automatically flagging the biometric verification request for review.

9. The method of claim 8, further comprising extracting the audio content from the video content at the biometric identity verification platform.

10. The method of claim 9, further comprising:
transmitting the audio content to a voice transcription service; and
receiving the machine-generated transcript corresponding to the audio content, the machine-generated transcript including text corresponding to the audio content and an identification of the number of speakers included in the audio content.

11. The method of claim 8, further comprising:
generating a summary report including details of a result of the biometric verification request, the summary report identifying the autonomy risk event;
generating a user interface including a plurality of result records summarizing results of a plurality of biometric verification requests associated with an enrollment entity from a plurality of different user devices; and
in response to selection of a result record from among the plurality of result records by the enrollment entity, generating a display of the summary report.

12. The method of claim 8, further comprising performing at least one additional autonomy risk assessment that is based, at least in part, on the metadata associated with the user device and the video content to identify the autonomy risk event.

13. A biometric identity verification platform comprising:
a processor;
a memory communicatively connected to the processor, the memory storing one or more biometric analysis models and instructions which, when executed by the processor, cause the biometric identity verification platform to perform:
receiving, at a biometric identity platform, a biometric enrollment request from a user device, the biometric enrollment request including video content, the video content including user biometric information and metadata associated with the user device and the video content;
extracting audio content from the video content;
submitting the audio content to an automated transcription service to obtain a machine-generated transcript;
identifying a number of keywords in the machine-generated transcript;
identifying a number of speakers represented in the machine-generated transcript;
based on whether the number of speakers exceeds a first threshold and the number of keywords exceeds a second threshold, identifying an autonomy risk event; and
based on presence of the autonomy risk event, automatically flagging the biometric enrollment request for review.

14. The biometric identity verification platform of claim 13, wherein the instructions further cause the biometric identity verification platform to perform at least one additional autonomy risk assessment that is based, at least in part, on the metadata associated with the user device and the video content to identify the autonomy risk event.

15. The biometric identity verification platform of claim 14, wherein the metadata associated with the user device and the video content identifies a camera of the user device used to capture the video content from among a front-facing camera and a rear-facing camera of the user device.

16. The biometric identity verification platform of claim 13, wherein the automated transcription service is remote from the biometric identity verification platform.

17. The biometric identity verification platform of claim 13, wherein the instructions further cause the biometric identity verification platform to:
generate a summary report including details of a result of the biometric enrollment request, the summary report identifying the autonomy risk event;
generate a user interface including a plurality of result records summarizing results of a plurality of biometric enrollment requests associated with an enrollment entity from a plurality of different user devices; and
in response to selection of a result record from among the plurality of result records by the enrollment entity, generate a display of the summary report.

18. The biometric identity verification platform of claim 13, wherein submitting the audio content to the automated transcription service includes providing an identification of a transcription language to the automated transcription service, the transcription language corresponding to a device language of the user device identified in the metadata.

19. The biometric identity verification platform of claim 13, wherein the instructions further cause the biometric identity verification platform to:
perform one or more biometric verification processes using the video content received from the user device.

20. The biometric identity verification platform of claim 19, wherein the instructions further cause the biometric identity verification platform to:
receive a biometric identity verification request including second video content; and
based on at least the second video content and biometric data obtained from the video content, utilizing the one or more biometric analysis models to verify an identity of a user associated with the second video content as corresponding to a same user depicted in the video content.
